(19) United States
(12) Patent Application Publication
(10) Pub. No.: US 2024/0033909 A1
(43) Pub. Date: Feb. 1, 2024

(54) CONTROL DEVICE, ROBOT CONTROL DEVICE, AND CONTROL METHOD

(71) Applicant: FANUC CORPORATION, Minamitsuru-gun, Yamanashi (JP)

(72) Inventors: Kouichirou HAYASHI, Yamanashi (JP); Hajime SUZUKI, Yamanashi (JP)

(21) Appl. No.: 18/017,755

(22) PCT Filed: Aug. 16, 2021
(86) PCT No.: PCT/JP2021/029861

§ 371 Date: Jan. 24, 2023

(30) Foreign Application Priority Data
Aug. 21, 2020 (JP) 2020-139925

(51) Int. Cl. B25J 9/16

(52) U.S. Cl. CPC B25J 9/163

(57) ABSTRACT

The present invention improves a vibration-dampening effect produced through learning in a state during production on a user side. This control device, which prepares a correction amount for controlling the operations of a robot, comprises: a learning control unit that has a parameter used in a learning control for preparing the correction amount; a parameter storage unit that stores a parameter set prior to shipment; and a parameter adjustment unit that, during production by the robot, adjusts the parameter stored by the parameter storage unit and sets the adjusted parameter in the learning control unit. The parameter adjustment unit adjusts the parameter on the basis of, e.g., the multiplicative inverse of a frequency response characteristic of the robot. The parameter adjustment unit also adjusts the parameter according to, e.g., a genetic algorithm.

### TECHNICAL FIELD

The present invention relates to a controller, a robot controller, and a control method, and particularly to a controller, a robot controller, and a control method for the controller that create a compensation amount for controlling a motion of a robot.

### BACKGROUND ART

An increase in speed and improvement of path accuracy by way of vibration reduction during a motion of a robot leads to improvements in production efficiency and quality. Therefore, there is a demand to reduce vibration or path divergence that occurs during the motion of the robot. In response to such a demand, Patent Document 1 proposes a method of reducing vibration by means of learning control that is performed using a sensor such as an acceleration sensor. According to this method, the sensor is installed at a location where removal of vibration is desired or a location where a high precision path is desired, and measures vibration during a motion of a robot.

Specifically Patent Document 1 discloses a robot including a robot mechanical unit that includes a sensor at a part as a position control target and a controller that controls a motion of the robot mechanical unit. The controller includes a normal control unit that controls the motion of the robot mechanical unit and a learning control unit that causes the robot mechanical unit to move according to a task program and performs learning for calculating a learning compensation amount to bring the position as the position control target of the robot mechanical unit, which is detected by the sensor, closer to a target path or position assigned for the normal control unit.

Patent. Document 1: Japanese Unexamined Patent Application, Publication No.2011-167817

### DISCLOSURE OF THE INVENTION

### Problems to be Solved by the Invention

A learning control unit generated before robot shipment does not take into account an operating (producing) state where a robot will be operating at a user's end (for example, tools and postures of the robot). The learning control unit generated based on frequency response characteristics in a standard load state before robot shipment may not be able to obtain the optimum effect at the time of production at the user's end. In order to enhance the effect of vibration reduction by learning at the time of production at the user's end, a controller, a robot controller, and a control method for a controller are required, the controller including a learning control unit taking into account frequency response characteristics at the time of production.

### Means for Solving the Problems

(1) A first aspect of the present disclosure is directed to a controller for creating a compensation amount for controlling a motion of a robot, the controller including:
   a learning control unit that has a parameter for use for learning control for creating the compensation amount;
   a parameter storage unit that stores the parameter set before shipment; and
   a parameter adjustment unit that, at a time of production by the robot, adjusts the parameter stored in the parameter storage unit and sets the adjusted parameter in the learning control unit.
(2) A second aspect of the present disclosure is directed to a robot controller including: the controller according to (1) described above; and a motion control unit that receives an input of the compensation amount for controlling the motion of the robot from the controller and controls the motion of the robot.
(3) A third aspect of the present disclosure is directed a control method for a controller that creates a compensation amount for controlling a motion of a robot, the control method including:
   reading a parameter for use for learning control for creating the compensation amount before shipment from a parameter storage unit; and
   adjusting the parameter stored in the parameter storage unit at a time of production by the robot, based on a reciprocal of a frequency response characteristic of the robot.

### Effects of the Invention

According to the aspects of the present disclosure, it is possible to enhance the effect of vibration reduction by learning at the time of production at the user's end.

### BRIEF DESCRIPTION OF THE DRAWINGS

FIG. 1 is a configuration diagram showing a configuration example of a robot system according to an embodiment of the present invention.

FIG. 2 is a configuration diagram of a robot mechanical unit shown in FIG. 1.

FIG. 3 is a block diagram showing a configuration of a robot controller.

FIG. 4 is a Bode plot showing an example of frequency characteristics of an input/output gain and a phase lag.

FIG. 5 is an explanatory diagram showing a state where a real path yᵢ(t) approaches an ideal path r(t) by learning.

FIG. 6 is a characteristic diagram showing reciprocals of two frequency characteristics of an input/output gain and a phase lag before shipment and frequency characteristics of a learning control unit.

FIG. 7 is a characteristic diagram showing reciprocals of seven frequency characteristics of the input/output gain and the phase lag and frequency characteristics of the learning control unit at the time of production at a user's end.

FIG. 8 is a block diagram showing a configuration or a motion control unit.

FIG. 9 is a flowchart showing an operation of a robot control method of the robot controller in an environment at the time of production at the user's end.

### PREFERRED MODE FOR CARRYING OUT THE INVENTION

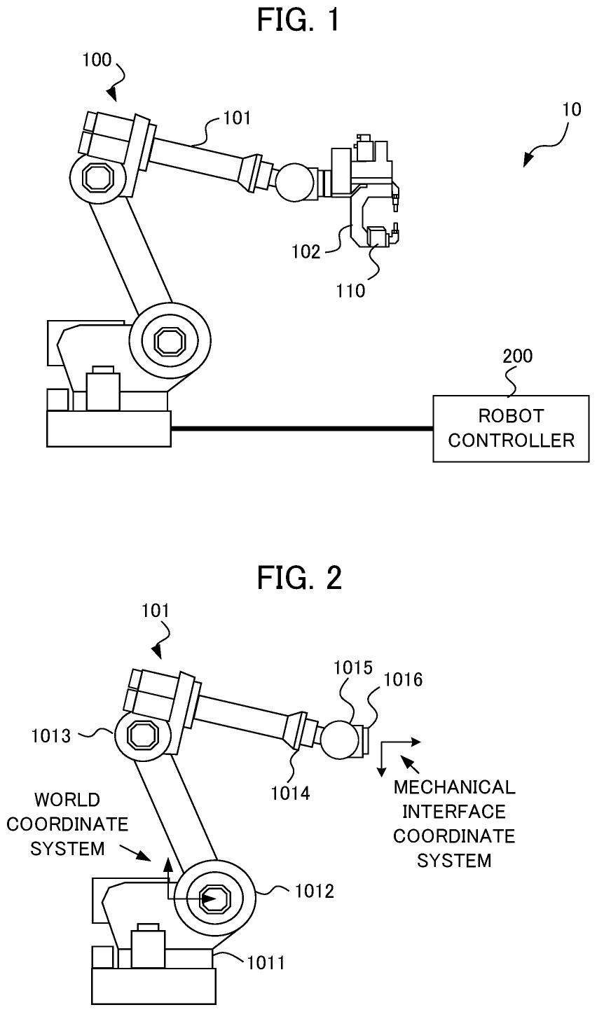

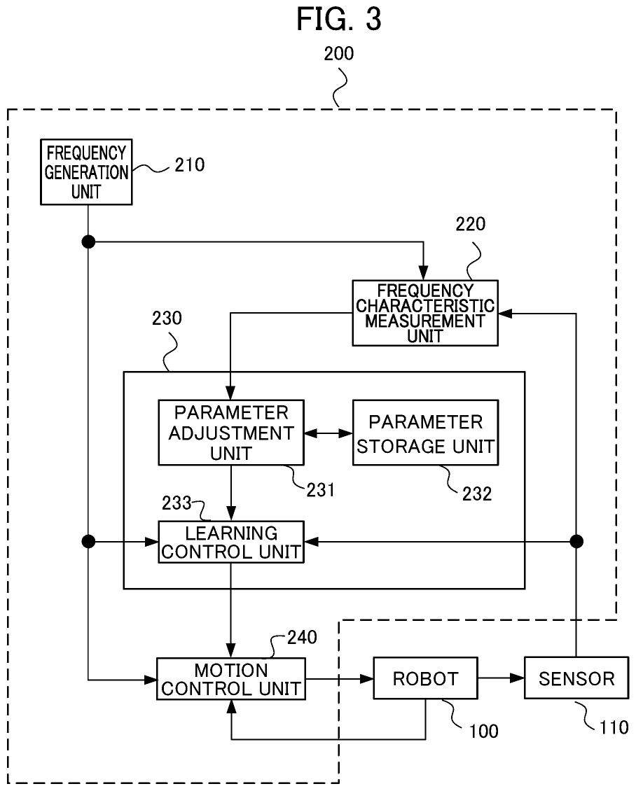

Hereafter, an embodiment of the present invention will be described in detail with reference to the drawings. FIG. 1 is a configuration diagram showing a configuration example of a robot system according to an embodiment of the present invention. FIG. 2 is a configuration diagram of a robot mechanical unit shown in FIG. 1. FIG. 3 is a block diagram showing a configuration of a robot controller.

As shown in FIG. 1, a robot system 10 includes a spot welding robot 100 and a robot controller 200 that controls a motion of the robot 100. The robot 100 and the robot controller 200 are connected to each other via cables.

The robot 100 includes a robot mechanical unit 101, a spot welding gun 102 attached to a tip of the robot mechanical unit 101, and a sensor 110 such as an acceleration sensor attached to the spot welding gun 102. The spot welding gun 102 serves as a position detection part of the robot. When the sensor 110 is connected in a wired manner, the sensor 110 is connected to the robot controller 200 via cables, and when the sensor 110 is connected in a wireless manner, the sensor 110 wireless communicates with the robot controller 200. While the sensor 110 of the present embodiment is an acceleration sensor, the sensor 110 may be of a different type, for example, a gyro sensor, an inertia sensor, a force sensor, a laser tracker, a camera, or a motion capture. As shown in FIG. 2, the robot mechanical unit 101 has six joint axes 1011 to 1016, and each of the joint axes 1011 to 1016 is provided with a motor. The robot 100 is defined with a world coordinate system fixed in a space and a mechanical interface coordinate system being at a flange position of the robot 100.

The robot controller 200 includes a frequency generation unit 210, a frequency characteristic measurement unit 220, a. control unit 230, and motion control unit 240, as shown in FIG. 3. The control unit 230 includes a parameter adjustment unit 231, a parameter storage unit 232, and a learning control unit 233. The control unit 230 corresponds to a controller. One or more of the frequency generation unit 210, the frequency characteristic measurement unit 220, and the control unit 230 may be provided within the motion control unit 240. One or both of the frequency generation unit 210 and the frequency characteristic measurement unit 220 may be provided within the control unit 230.

The frequency generation unit 210 outputs sine wave signals as motion commands to the frequency characteristic measurement unit 220, the control unit 230, and the motion control unit 240, while changing a frequency.

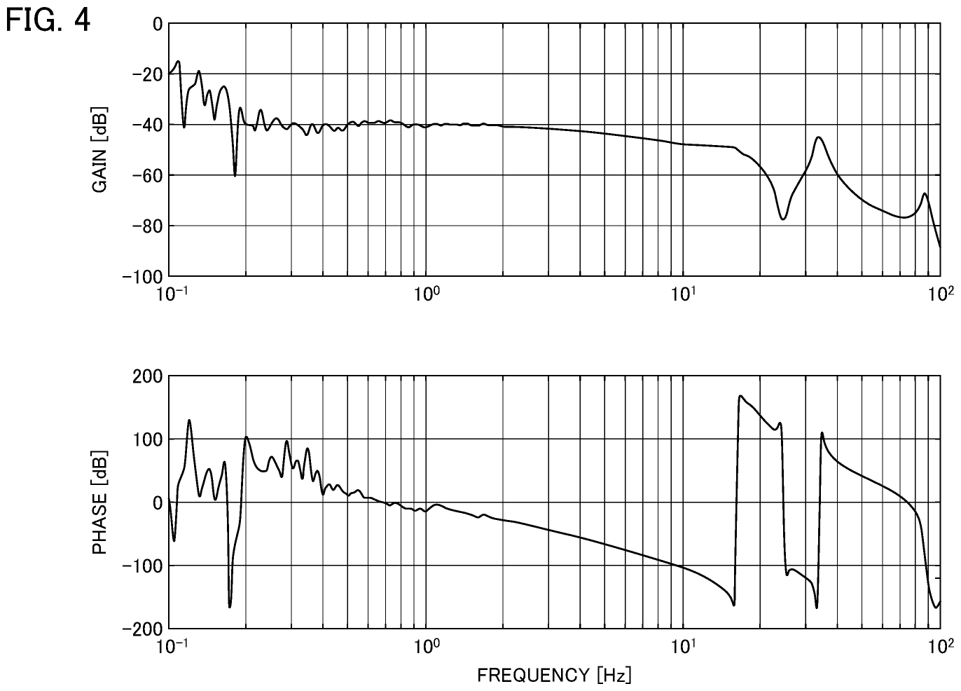

The frequency characteristic measurement unit 220 measures an amplitude ratio (input/output gain) between an input signal and an output signal and a phase lag for each of frequencies defined by the motion commands, using a motion command (sine wave) as an input signal generated by the frequency generation unit 210 and a detection position (sine wave) as an output signal output from the sensor 110. The frequency characteristic measurement unit 220 outputs frequency characteristics (frequency response characteristics) at the measured input/output gain and phase lag to the parameter adjustment unit 231 of the control unit 230. Before shipment, the frequency characteristic measurement unit 220 measures frequency characteristics of the input/output gain and the phase lag when the robot 100 moves in several postures (inertia) under a maximum load test workpiece and a no-load state, and outputs the measured frequency characteristics to the parameter adjustment unit 231 of the control unit 230. FIG. 4 is a Bode plot showing an example of frequency characteristics of an input/output gain and a phase lag. Further, the frequency characteristic measurement unit 220 measures the frequency characteristics of the input/output gain and the phase lag when the robot 100 moves in an environment at the time of production at a user's end, and outputs the frequency characteristics to the parameter adjustment unit 231 of the control unit 230.

Here, the time of production includes a time of learning before actual production at the user's end, and the environment at the time of production at this time is an environment with the same tools and postures as in the actual production. However, when the parameter adjustment unit 231 adjusts parameters of the learning control unit 233 while the production is actually being performed, the time of production means a time when the production is actually being performed. Hereinafter, the “time of production” may refer to he time of learning before the production is actually performed at the user's end or a time when the production is actually being performed at the user's end. The parameters of the learning control unit 233 are internal parameters of a transfer function of constituent elements of the learning control unit 233. When the learning control unit 233 includes a band pass filter Wₜ, a low pass filter Q, a learning controller L, and a high pass filter Wₚ, the parameters of the learning control unit 233 are internal parameters of a transfer function of each of the band pass filter Wₜ, the low pass filter Q, the learning controller L, and the high pass filter Wₚ. The internal parameters of the transfer function of each of the band pass filter Wₜ, the low pass filter Q, the learning controller L, and the high pass filter Wₚ will be described below. The production is not limited to factory-based manufacturing activities, but refers to activities that bring out goods, services, or added values capable of being used by the robot. For example, the production includes activities performed by agricultural robots such as fruit harvesting robots, forestry robots such as branch cutting robots, and commercial robots such as transport robots.

Before shipment, the parameter adjustment unit 231 calculates reciprocals of the frequency characteristics (frequency response characteristics) of the input/output gain and the phase lag output from the frequency characteristic measurement unit 220, adjusts the parameters of the learning control unit 233 based on the reciprocals, and determines optimum parameters, and the optimum parameter are stored in the parameter storage unit 232 and are set in the learning control unit 233. In this way, a pre-shipment learning control unit is generated. At the time of production at the user's end, the parameter adjustment unit 231 reads parameters from the parameter storage unit 232, sets the read parameters as initial parameters, calculates the reciprocals of the frequency characteristics output from the frequency characteristic measurement unit 220, adjusts the initial parameters of the learning control unit 233 based on the reciprocals, and determines optimum parameters, and the optimum parameters are set in the learning control unit 233. In this way, a learning control unit at the time of production at the user's end is generated.

The learning control unit 233 calculates a compensation amount to bring the detection position output from the sensor 110 closer to a target position of the motion command. Further, the learning control unit 233 inversely transforms the calculated compensation amount to obtain a compensation amount corresponding to each of the joint axes 1011 to 1016, and outputs the calculated compensation amount of each of the joint axes to the motion control unit 240. The motion control unit 240 uses the compensation amount outputs from the learning control unit 233 to control each of the joint axes of the robot 100. Vibration on the world coordinate system is compensated when vibration of each of the joint axes is compensated.

The parameter adjustment unit 231, the learning control unit 233, and the motion control unit 240 will be described in more detail below.

### <Learning Control Unit>

The learning control unit 233 updates the compensation amount by using iterative learning control to bring the detection position output from the sensor 110 closer to the target position of the motion command. The iterative learning control is disclosed in, for example, “Survey of Iterative Learning Control: A Learning-Based Method for High-Performance Tracking Control”, Bristow, D. A., Tharayil M., & Alleyne, A. G. (2006), IEEE Control Systems, 26(3), 96-114., “Iterative Learning Control Analysis, Design, and Experiments”, Mikael Norrlof, Department of Electrical Engineering Linkopings universitet, SE-581 83 Linkoping, Sweden Linkoping 2000.

The output (compensation amount) from the learning control unit 233 to the motion control unit 240 is updated according to Expression 1 (Math. 1 below). In Expression 1, uᵢ₊₁(t) represents an output (compensation amount) to the motion. control unit 240 in (i+1)-th learning, uᵢ(t) represents an output (compensation amount) to the motion control unit 240 in i-th learning, eᵢ(t) represents a path error in the i-th learning, Q represents a transfer function of the low pass filter included in the learning control unit 233, and L represents a transfer function of the learning controller (digital filter) included in the learning control unit 233. When a real path of the robot in the i-th learning is represented by yᵢ(t) and an ideal path (command path) is represented by r(t) , the path error eᵢ(t) is expressed by Expression 2 (Math. 2 below). The real path yᵢ(t) of the robot corresponds to the detection position output from the sensor 110, and the ideal path r(t) corresponds to the motion command (position command) output from the frequency generation unit 2100.

uᵢ₊₁(t)=Q(uᵢ(t)+Leᵢ(t)) [Math. 1]

eᵢ(t)=r(t)−yᵢ(t) [Math. 2]

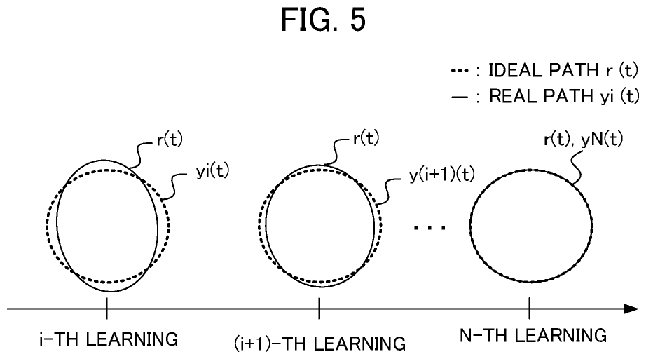

FIG. 5 is an explanatory diagram showing a state where the real path yᵢ(t) approaches the ideal path r(t) by learning.

The following two properties are important for the learning control unit 233.

### (1) Stability

It is important to converge to a bounded value u_{∞}(t) as indicated in Expression 3 (Math. 3 below) without diverging of the output (compensation amount) uᵢ(t) to the motion control unit 240.

$${lim}_{i \to ∞} ‖ {u}_{i} ( t ) - {u}_{∞} ( t ) ‖ = 0 \qquad [ Math . 3 ]$$

### (2) Characteristic of Monotonic Decrease

A case is often not accepted in practical use where the path error eᵢ(t) is converged with an increase once. Therefore, as indicated by Expression 4 (Math. 4 below), it is important to have a characteristic of monotonic decrease in which the path error eᵢ(t) is uniformly converged to a certain bounded value e_{∞}.

γ<1, ∥eᵢ₊₁−e_{∞}∥≤γ∥eᵢ−e_{∞}∥ [Math. 4]

A relationship between the compensation amount uᵢ(t) in the i-th learning and the compensation amount uᵢ₊₁(t) is the (i+1)-th learning satisfies a relational expression indicated by Expression. 5 (Math. 5 below), and a relationship between the path error eᵢ(t) in the i-th learning and the path error eᵢ₊₁(t) in the (i+1)-th learning satisfies a relational expression indicated by Expression 6 (Math. 6 below). In Expression 5 and Expression 6, Q represents a transfer function of the low pass filter, L represents a transfer function of the learning controller, and P represents a transfer function from the output of the compensation amount of the motion control unit 240 to the output to the robot 100.

$$\begin{matrix}{‖ {u}_{i + 1} ( t ) - {u}_{∞} ( t ) ‖}_{2} \leq {‖ Q ( 1 - LP ) ‖}_{∞} {‖ {u}_{i} ( t ) - {u}_{∞} ( t ) ‖}_{2} \\ {u}_{∞} = \frac{QL}{1 - Q ( 1 - LP )} r & [ Math . 5 ] \\ {‖ {e}_{i + 1} ( t ) - {e}_{∞} ( t ) ‖}_{2} \leq {‖ Q ( 1 - LP ) ‖}_{∞} {‖ {e}_{i} ( t ) - {e}_{∞} ( t ) ‖}_{2} \\ {e}_{∞} = \frac{1 - Q}{1 - Q ( 1 - LP )} r & [ Math . 6 ]\end{matrix}$$

In Expression 5 and Expression 6 above, when Expression 7 (Math. 7 below) is equal to 1 or smaller than 1, the compensation amount and the path error are converged to u_{∞}(t) and e_{∞}(t), respectively, and the stability and the characteristic monotonic decrease are maintained.

∥Q(1−LP)∥_{∞} [Math. 7]

Conditions for maintaining the stability and the characteristic of monotonic decrease of the learning control unit 233 are as described above. When the learning control unit 233 includes the band pass filter Wt, the low pass filter Q, the learning controller L, and the high pass filter Wp, the parameter adjustment unit 231 designs the internal parameters to be described below of the transfer function of the learning control unit 233 such that Expression 8 (Math. 8 below) is minimized.

∥WtQ(1−LWpP)∥_{∞} [Math. 8]

The transfer function of the band pass filter Wt has, as internal parameters, a pass band (wt) and a gain (dcwt) in the pass band. The transfer function of the low pass filter Q has, as internal parameters, a filter order (Nq) and a cut-off frequency (wn). The transfer function of the learning controller L has, as internal parameters, a value (N_ILC) indicating whether a vibration of which sample is used and a sample order (No). The transfer function of the high pass filter Wp has, as internal parameters, a cut-off frequency (wp), a filter gain (dcwp), and a filter order (wpNo).

### <Parameter Adjustment Unit>

Before shipment the parameter adjustment unit 231 acquires, from the frequency characteristic measurement unit 220, a plurality of frequency characteristics of the input/output gain and the phase tag when the robot 100 moves in several postures (inertia) under a maximum load test workpiece and no-load state, and obtains reciprocals of these frequency characteristics. Then, the parameter adjustment unit 231 changes at least one selected from nine internal parameters of the transfer function of the band pass filter Wt, the low pass filter Q, the learning controller L, and the high pass filter Wp, for example, changes two internal parameter of the transfer function of the learning controller L such that the frequency characteristics of the learning control unit 233 are the reciprocals of the plurality of frequency characteristics. The frequency characteristics of the learning control unit 233 are desirably close to the reciprocals of the plurality of measured frequency characteristics of the input/output gain and the phase lag. The reason is that the frequency characteristics of the learning control unit 233 match the reciprocals of the measured frequency characteristics and thus the compensation amount created by the learning control unit 233 works as a compensation in a direction opposite to the vibration, whereby the vibration of the robot 100 can be canceled.

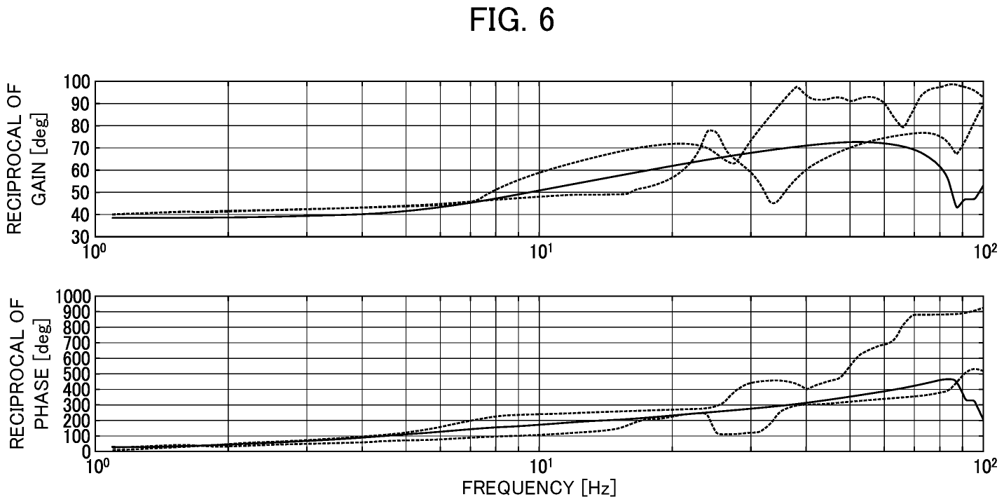

FIG. 6 is a characteristic diagram showing reciprocals of two frequency characteristics of the input/output gain and the phase lag before shipment and frequency characteristics of the learning control unit. In FIG. 6, broken lines indicate reciprocals of plurality of frequency characteristics of the input/output gain and the phase lag, and solid lines indicate frequency characteristics of the learning control unit 233. All of the frequency characteristics (reciprocals of the plurality of frequency characteristics of the input/output gain and phase lag) indicated by the broken lines and the frequency characteristics indicated by the solid lines represent frequency characteristics before learning. In FIG. 6, the two broken lines indicate the reciprocals of the frequency characteristics when the robot 100 moves in two types of postures (inertia). The content parameters are adjusted to the reciprocals of the two frequency characteristics of the input/output gain and the phase lag in two types of postures to change the frequency characteristics of the learning control unit 233 indicated by the solid lines, and thus vibration at the time of two types of postures is prevented. However, when the robot 100 moves in another posture (inertia) in an environment at the time of production at the user's end, vibration may not be prevented in the content parameters before shipment.

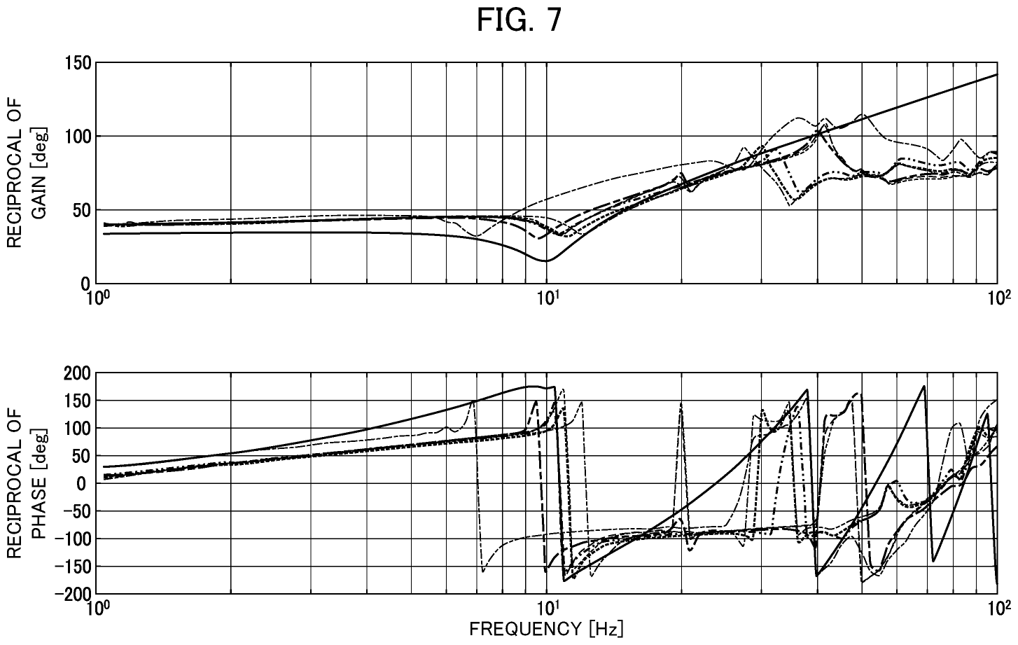

Therefore, the parameter adjustment unit 231 adjusts the internal parameters to be the reciprocals of the frequency characteristics of input/output gain and the phase lag which are measured at the time of production at the user's end. At this time, the parameter adjustment unit 231 reads the parameters as initial parameters from the parameter storage unit 232, adjusts the initial parameters of the learning control unit 233 based on the reciprocals of the frequency characteristics output from the frequency characteristic measurement unit 220, determines optimum internal parameters, and sets the internal parameters in the learning control unit 233. FIG. 7 is characteristic diagram showing reciprocals of seven frequency characteristics of the input/output gain and the phase lag and frequency characteristics of the learning control unit at the time of production at the user's end. In FIG. 7, a thick dashed-dotted line, a thin dashed-dotted line, a thick dashed-two-dotted line, a thin dashed-two-dotted line, a thick broken line, a thin broken line, and a widely spaced broken line indicate reciprocals of seven frequency characteristics of the input/output gain and the phase lag and frequency characteristics of the learning control unit, and solid lines indicate frequency characteristics of the learning control unit 233. As shown in FIG. 7, all of the reciprocals of the plurality of frequency characteristics of the input/output gain and the phase lag and the frequency characteristics indicated by the solid lines represent frequency characteristics before learning. The content parameters are adjusted to the reciprocals of the seven frequency characteristics in seven types of postures (inertia) to change the frequency characteristics of the learning control unit 233 indicated by the solid lines, and thus vibration at the time of seven types of postures is prevented. The inertia changes not only depending on the posture, but also depending on a load (for example, a servo gun attached to the tip of the robot).

A method of searching for the optimum internal parameters with the parameter adjustment unit 231 is not particularly limited, but can use a genetic algorithm, which will be described below, for example.
(1) Two sets containing N individuals (N being a natural number equal to or greater than 2) are prepared in advance. Hereinafter, the two sets will be called “current generation” and “next generation”. One individual has information on nine internal parameters described above.
(2) N individuals are randomly generated in the current generation. Each of the individuals is randomly generated within an allowable range of the internal parameters.
(3) Fitness of each individual in the current generation is calculated using an evaluation function. The fitness becomes higher as Expression 8, which is the evaluation function, becomes smaller. It is possible to decide whether each individual (combination of the parameters) is a good learning controller based on the fitness.
(4) Any of the following three processes is performed with a certain probability, and the result thereof is saved in the next generation. A. Selecting and crossing over two individuals. Taking over parameters possessed by any one of the current generation individuals to the next generation individuals. B. Selecting one individual and performing mutation. Randomly altering some or all of parameters of the selected individual. C. Selecting and copying as it is one individual.
(5) Iteratively performing the process (4) above until the number of individuals in the next generation reaches N.
(6) Transferring all the contents of the next generation to the current generation when the number of individuals in the next generation reaches N.
(7) Iteratively performing the following processes including the process (3) above up to the maximum number of generations G (G being a natural number equal to or greater than 2), and finally outputting, as a “solution”, the individual with the highest fitness in the “current generation”.

### <Motion Control Unit>

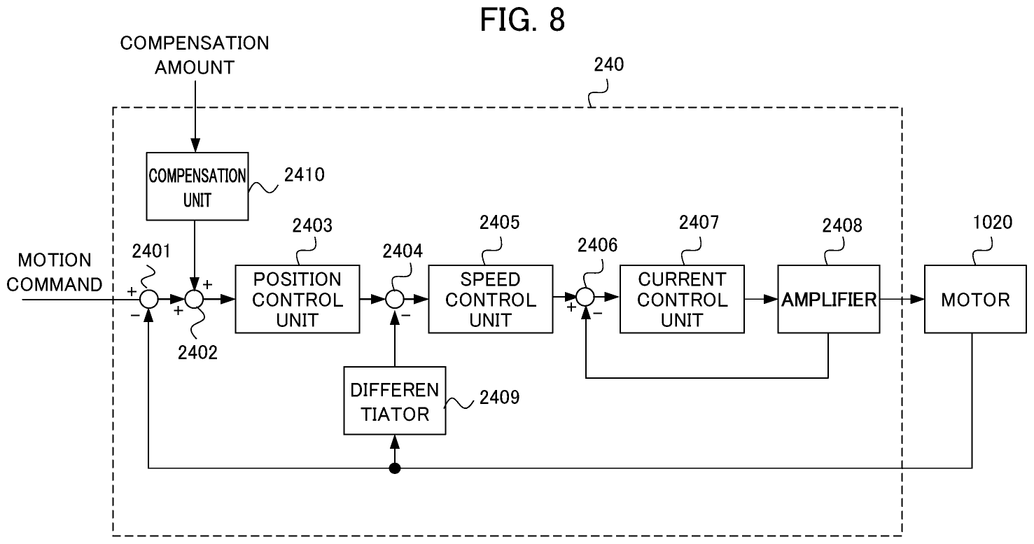

FIG. 8 a block diagram showing a configuration of the motion control unit 240. The motion control unit 240 is provided corresponding to each of the six joint axes 1011 to 1016, but the motion control unit 240 is configured to control the motor 1020 of the joint axis 1011 of the robot 100 in the following description. As shown in FIG. 8, the motion control unit 240 includes a subtractor 2401, an adder 2402, a position control unit 2403, subtractor 2404, a speed control unit 2405, a subtractor 2406, a current control unit 2407, an amplifier 2408, a differentiator 2409, and a compensation unit 2410.

The subtractor 2401 obtains a difference between a command position of the motion command and a position feedback value output from a position detector such as a rotary encoder of the motor 1020 of the joint axis of the robot, and outputs the difference as a positional deviation to the adder 2402. The adder 2402 adds a positional deviation output from the subtractor 2401 and a compensation amount output from the compensation unit 2410, and outputs the compensated positional deviation to the position control unit 2403.

The position control unit 2403 generates a speed command value based on the compensated positional deviation, and outputs the generated speed command to the subtractor 2404. The subtractor 2404 obtains a difference between the speed command value output from the position control unit 2403 and a speed feedback value output from the differentiator 2409, and outputs the difference as a speed deviation to the speed control unit 2405.

The speed control unit 2405 generates a current command value based on the speed deviation, and outputs the current command value to the subtractor 2406. The subtractor 2406 obtains a difference between the current command value output from the speed control unit 2405 and a current feedback value output from the amplifier 2408, and outputs the difference as a current deviation to the current control unit 2407. The current control unit 2407 generates a torque command value (current value) based on the current deviation, and outputs the torque command value to the amplifier 2408. The amplifier 2408 calculates desired power based on the current value output from the current control unit 2407, and inputs the power to the motor 1020 of the joint axis 1011 of the robot 100. The differentiator 2409 differentiates the position feedback value, and outputs it to the subtractor 2404. The compensation unit 2410 stores the compensation amount output from the learning control unit 233, and outputs the compensation amount to the adder 2402.

In order to implement the functional blocks of the robot controller 200 shown in FIG. 1, the robot controller 200 can be constituted by a computer including an arithmetic operation processing device such as a CPU (Central Processing Unit). Further, the robot controller 200 also includes an auxiliary storage device such as an HDD (Hard Disk Drive) for storing various control programs such as application software or an OS (Operating System) and a main storage device such as a RAM (Random Access Memory) for storing data temporarily required for the arithmetic operation processing device to execute programs.

In the robot controller 200, the arithmetic operation. processing device reads the application software or OS from the auxiliary storage device, and performs arithmetic operation processing based on the application software or OS, while deploying the read application software or OS to the main storage device. Further, the arithmetic operation processing device controls various hardware provided in the robot controller 200, based on arithmetic results. Thus, the functional blocks of the present embodiment are implemented. In other words, the present embodiment can be realized by cooperation of hardware and software.

For the learning control unit 233, when the amount of arithmetic operations accompanied by learning is large, for example, a GPU (Graphics Processing Units) is equipped in a personal computer, and the GPU is used for arithmetic operation processing accompanied by machine learning with a technique called GPGPU (General-Purpose computing on Graphics Processing Units) to perform high-speed processing. Further, in order to perform higher-speed processing, a computer cluster is constructed using a plurality of computers equipped with such a GPU, and the plurality of computers included in the computer cluster may perform parallel processing.

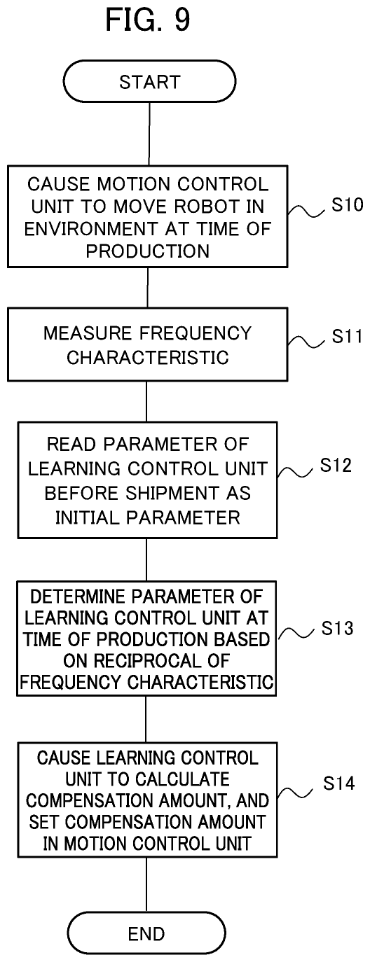

Next, a description will be given with respect to the operation of the robot controller 200 in the environment at the time of production at the user's end. FIG. 9 is a flowchart showing an operation of a robot control method of the robot controller 200 in the environment at the time of production at the user's end. The parameter storage unit 232 shown in FIG. 1 stores the optimum parameters of the learning control unit 233 before shipment. The optimum parameters are determined in a manner that the parameter adjustment unit 231 adjusts the parameters of the learning control unit 233 based on the reciprocals of the frequency characteristics (frequency response characteristics) of the input/output gain and the phase lag which are output from the frequency characteristic measurement unit 220 before shipment.

In Step S10, the frequency generation unit 210 outputs sine wave signals as motion commands to the motion control unit 240 in the environment at the time of production at the user's end, and the motion control unit 240 causes the robot 100 to move.

In Step S11, the frequency characteristic measurement unit 220 measures an amplitude ratio (input/output gain) between the input signal and the output signal and a frequency characteristic of the phase lag, the motion command (sine wave) generated by the frequency generation unit 210 and the detection position (sine wave) output from the sensor 110.

In Step S12, the parameter adjustment unit 231 reads the parameters as initial parameters of the control unit 230 before shipment from the parameter storage unit 232.

In Step S13, the parameter adjustment unit 231 calculates reciprocals of the frequency characteristics output from the frequency characteristic measurement unit 220, adjusts the initial parameters of the learning control unit 233 based on the reciprocals, determines optimum parameters, and sets the optimum parameter in the learning control unit 233.

In Step S14, the learning control unit 233 calculates a compensation amount to bring the detection position output from the sensor 110 closer to the target position of the motion command, and the motion control unit 240 uses the compensation amount to control each of the joint axes of the robot 100.

The control unit (to be a controller) described above can enhance the effect of vibration reduction by learning at the time of production at the user's end. Further, since the control unit adjusts the parameters of the learning control unit using the initial parameters at the time of production at the user's end, there is no need to significantly change the parameters, and the number of trials can be set to be small. As a result, the adjustment time at the user's end can be shortened. In addition, when the control unit adjusts the parameters of the learning control unit based on the frequency characteristics output from the frequency characteristic measurement unit without using the initial parameters before shipment at the time of production at the user's end, although there is a possibility that the learning control unit will cause vibration to diverge when the frequency characteristics are changed, the divergence can be prevented using the initial parameters before shipment.

Although the embodiment according to the present invention has been described above, each of the components of the controller, the robot controller, and the control method of the embodiment can be implemented by hardware, software, or a combination thereof. For example, each of the components may be implemented by an electronic circuit. Further, an image processing method performed by cooperation of each of the components can also be implemented by hardware, software, or a combination thereof. Here, the implementation by software means that each of the components is implemented when a computer reads and executes a program.

The program may be stored and supplied to a computer using various types of non-transitory computer readable media. The non-transitory computer readable media include various types of tangible storage media. Examples of the non-transitory computer readable media include a magnetic recording medium (for example, a hard disk drive), a magneto-optic recording medium (for example, a magneto-optic disk), a CD-ROM (Read Only Memory), a CD-R, a CD-R/W, and a semiconductor memory (for example, a mask ROM, a PROM (Programmable ROM), an EPROM (Erasable PROM), a flash ROM, and a RAM (random access memory)).

Although the above-described embodiment is a preferred embodiment of the present invention, the scope of the present invention is not limited only to the above-described embodiment, and various modifications can be made without departing from the gist of the present invention.

For example, the above-described embodiment is configured in which the robot system 10 is separated into the robot 100 and the robot controller 200, but the robot controller 200 may be included in the robot 100.

In the above-described embodiment, as the robot, the spot welding robot has been described, but another robot, for example, a painting robot, an assembly robot, or a transport robot may be used.

The controller, the robot controller, and the control method according to the present disclosure can take various embodiments including the above-described embodiment having the following configurations.
(1) A first aspect of the present disclosure provides a controller (for example, control unit 230) that creates a compensation amount for controlling a motion of a robot (for example, robot 100), the controller including:
   a learning control unit (for example, learning control unit 233) that has a parameter for use for learning control for creating the compensation amount;
   a parameter storage unit (for example, parameter storage unit 232) that stores the parameter set before shipment; and
   a parameter adjustment unit (for example, parameter adjustment unit 231) that, at a time of production by the robot, adjusts the parameter stored in the parameter storage unit and sets the adjusted parameter in the learning control unit. According to the controller, it is possible to enhance the effect of vibration reduction by learning at the time of production at the user's end.
(2) the controller according to (1) above, the parameter adjustment unit adjusts the parameter based on a reciprocal of a frequency response characteristic of the robot.
(3) In the controller according to (1) or (2) above, the parameter adjustment unit adjusts the parameter using a genetic algorithm.
(4) A second aspect of the present disclosure provides a robot controller including: the controller according to any one of (1) to (3) above; and
   a motion control unit that receives an input of the compensation amount for controlling the motion of the robot from the controller and controls the motion of the robot.

According to the robot controller, it is possible to enhance the effect of vibration reduction by learning at the time of production at the user's end.
(5) In the robot controller according to (4) above, the robot controller further includes: a frequency generation unit that generates a signal of which frequency changes; and
   a frequency characteristic measurement unit that measures a frequency response characteristic of the robot based on the signal and an output signal from a sensor attached to a position detection part of the robot
(6) In the robot controller according to (5) above, the sensor is one selected from an acceleration sensor, a gyro sensor, an inertia sensor, a force sensor, a laser tracker, a camera, and a motion capture.
(7) A third aspect of the present disclosure provides a control method for a controller (for example, control unit 230) that creates a compensation amount for controlling a motion of a robot (for example, robot 100), the control method including:
   reading a parameter for use for learning control for creating the compensation amount before shipment from a parameter storage unit (for example, parameter storage unit 232); and
   adjusting the parameter stored in the parameter storage unit at a time of production by the robot, based on a reciprocal of a frequency response characteristic of the robot.

According to the control method, it is possible to enhance the effect of vibration reduction by learning at the time of production at the user's end.

### EXPLANATION OF REFERENCE NUMERALS

10: robot system
100: robot
101: robot mechanical unit
102: spot welding gun
110: sensor
200: robot controller
210: frequency generation unit
220: frequency characteristic measurement unit
230: control unit
231: parameter adjustment unit
232: parameter storage unit
233: learning control unit
240: motion control unit

1. A controller for creating a compensation amount for controlling a motion of a robot, the controller comprising:
a learning control unit that has a parameter for use for learning control for creating the compensation amount;
a parameter storage unit that stores the parameter set before shipment; and
a parameter adjustment unit that, at a time of production by the robot, adjusts the parameter stored in the parameter storage unit and sets the adjusted parameter in the learning control unit.

2. The controller according to claim 1, wherein the parameter adjustment unit adjusts the parameter based on a reciprocal of a frequency response characteristic of the robot.

3. The controller according to claim 1, wherein the parameter adjustment unit adjusts the parameter using a genetic algorithm.

4. A robot controller comprising:
the controller according to claim 1; and
a motion control unit that receives an input of the compensation amount for controlling the motion of the robot from the controller and controls the motion of the robot.

5. The robot controller according to claim 4, further comprising:
a frequency generation unit that generates a signal of which frequency changes; and
a frequency characteristic measurement unit that measures a frequency response characteristic of the robot based on the signal and an output signal from a sensor attached to a position detection part of the robot.

6. The robot controller according to claim 5, wherein the sensor is one selected from an acceleration sensor, a gyro sensor, an inertia sensor, a force sensor, a laser tracker, a camera, and a motion capture.

7. A control method for a controller that creates a compensation amount for controlling a motion of a robot, the control method comprising:
reading a parameter for use for learning control for creating the compensation amount before shipment from a parameter storage unit; and
adjusting the parameter stored in the parameter storage unit at a time of production by the robot, based on a reciprocal of a frequency response characteristic of the robot.
